(19) United States
(12) Patent Application Publication
(10) Pub. No.: US 2026/0290861 A1
(43) Pub. Date: Sep. 24, 2026

(54) ELECTROCHEMICAL CELL

(71) Applicant: Saudi Arabian Oil Company, Dhahran (SA)

(72) Inventors: Aqil Jamal, Dhahran (SA); Alexey Izgorodin, Dhahran (SA)

(21) Appl. No.: 19/082,409

(22) Filed: Mar. 18, 2025

(51) Int. Cl. H01M 8/04082; H01M 8/04537; H01M 8/18; H01M 8/2404; H01M 8/2483

(52) U.S. Cl. CPC H01M 8/04201; H01M 8/04552; H01M 8/188; H01M 8/2404; H01M 8/2483

(57) ABSTRACT

An inlet stream is flowed to an electrical cell assembly disposed within a housing. The electrochemical cell assembly includes electrochemical cells. An incompressible adhesive hermetically seals the electrochemical cells within the housing to prevent the electrochemical cells from being exposed to pressure that is external to the incompressible adhesive. The inlet stream interacts with an electrolyte of at least one of the electrochemical cells in a reduction-oxidation reaction to produce an outlet stream. The outlet stream is discharged from the housing.

### TECHNICAL FIELD

This disclosure relates to electrochemical cells.

### BACKGROUND

Electrochemical cells generate electrical energy from chemical reactions. Electrical energy can also be applied to electrochemical cells to cause chemical reactions to occur. Electrochemical cells that generate an electric current can be called voltaic or galvanic cells. Electrochemical cells that perform electrolysis can be called electrolytic cells. Electrochemical cells can be used in a wide variety of applications, such as energy storage and chemicals production.

### SUMMARY

This disclosure describes technologies relating to electrochemical cells. The subject matter described in this disclosure can be implemented in particular implementations, so as to realize one or more of the following advantages. The electrochemical cell systems described allow for operation over extended pressure cycling, which is advantageous over conventional gasket-based systems and can provide long-term stability on an industrial scale. The electrochemical cell system is highly resistant to leaks, offering a significant safety advantage over alternative designs. This enhanced safety is particularly crucial when operating with flammable of hazardous fluids. The electrochemical cell systems described exhibit improved system volumetric density and gravimetric energy density in comparison to conventional electrochemical cell systems with comparable power output/input levels. The electrochemical cell systems described can be constructed at a reduced cost in materials in comparison to conventional electrochemical cell systems with comparable power output/input levels. The electrochemical cell systems described can be simpler to construct in comparison to conventional electrochemical cell systems with comparable power output levels, leading to improved manufacturing efficiency. The electrochemical cell systems described can be applied broadly across various fields, such as gas developing and gas consuming electrolytic reactions and processes. The electrochemical cell systems described can provide improved mass transfer of reactants and products within electrochemical cells with high energy efficiency, low gravimetric and low volumetric component requirements.

The details of one or more implementations of the subject matter of this disclosure are set forth in the accompanying drawings and the description. Other features, aspects, and advantages of the subject matter will become apparent from the description, the drawings, and the claims.

### DESCRIPTION OF DRAWINGS

FIG. 1A is a schematic diagram of an example electrochemical cell assembly.

FIG. 1B is a schematic diagram of an example electrochemical cell.

FIG. 1C is a schematic diagram of multiple neighboring electrochemical cells.

FIG. 1D is a schematic diagram of multiple neighboring electrochemical cells.

FIG. 2 is a schematic diagram of an example electrochemical cell system.

FIG. 3 is a flow chart of an example method of operating an electrochemical cell system.

FIG. 4A is a flow chart of an example method of producing an electrochemical cell system.

FIG. 4B is a schematic diagram of an example electrochemical cell assembly wrapped with a polymer sleeve.

FIG. 4C is a schematic diagram of an example electrochemical cell assembly at least partially covered with an incompressible adhesive.

FIG. 5 is a block diagram of an example computer.

### DETAILED DESCRIPTION

Electrochemical cells can be used in wide variety of applications ranging from energy storage to chemicals production and are fundamental to realize the global transition to clean energy use. The use of renewable energy sources (such as wind and solar) with inherent variability of electricity supply and gaseous feedstocks (such as carbon dioxide) introduces the need for a wider operating envelop, including a low minimum load operation and sufficient ramp up rates. In addition, variable electricity supply limits the number of operating hours of an industrial plant and underlines the importance of decreasing system capital costs and maintenance requirements. As one example, commercial systems for electrochemical hydrogen and oxygen production from water typically require operating at over 50% capacity due to the high volume-fraction of hydrogen in oxygen at lower capacity.

Conventional filter-press stack designs for electrochemical cells typically require alignment and compression of multiple components between end plates that are held by tie rods. The end plates of such electrochemical cells should be sufficiently thick to maintain uniform stack compression while the gaskets used to provide a hermetic seal should be precisely aligned and compressed to maintain leak-free operation. As such, these electrochemical cells can be prone to leakage. Further, conventional filter-press stack designs typically must operate within limited ranges of operating pressure and require high manufacturing costs. In contrast, the electrochemical cell assemblies and electrochemical cell systems described herein can provide an improved electrochemical cell stack at lower cost and mitigate and/or eliminate risk of leakage.

During operation of electrochemical cells at elevated pressures, the cells should be able to physically withstand the pressure difference between the inside and outside of the cells. Conventional electrochemical cells typically require strong and thick external walls to be able to withstand such pressure difference, which can be a complex and demanding hurdle to overcome. The electrochemical cell assemblies and electrochemical cell systems described herein ensure minimal pressure differential between the inside and outside of the cells by use of an annular adhesive that maintains a hermetic seal between individual electrochemical cells, thereby allowing the use of simple electrochemical cells that can be readily combined into such electrochemical cell assemblies, including in high speed, high volume industrial manufacturing processes.

This disclosure describes electrochemical cells, electrochemical cell assemblies, and electrochemical cell systems, which can be used, for example, in gas developing and/or gas consuming electrolytic reactions and processes. Examples of such processes include chlor-alkali electrolysis, water electrolysis, fuel cells, reversible energy storage, and carbon dioxide reduction processes. The assembly includes separators that separate a plurality of electrochemical cells into different compartments. The assembly includes a flow manifold and an electrical manifold. The flow manifold distributes reactant(s) to the electrochemical cells and receives product(s) from the electrochemical cells. The electrical manifold is electrically connected to the electrochemical cells for transmitting electrical power to/from the cells. The plurality of electrochemical cells can be sandwiched between end plates in fluid communication with the flow manifold. The assembly can be housed within an enclosure that minimizes pressure differential between the interiors and exteriors of the individual electrochemical cells. The enclosure can include a pipe and end caps located at opposite ends of the pipe. The assembly can be placed within the pipe. In some cases, the annulus between the pipe and the assembly includes an adhesive for securing the assembly within the enclosure. The assembly can, for example, be lowered into the pipe by using a sleeve. A system including the electrochemical cell assembly allows use of simple electrochemical cells that can be readily combined into the electrochemical cell assembly, including in high speed and high volume industrial processes.

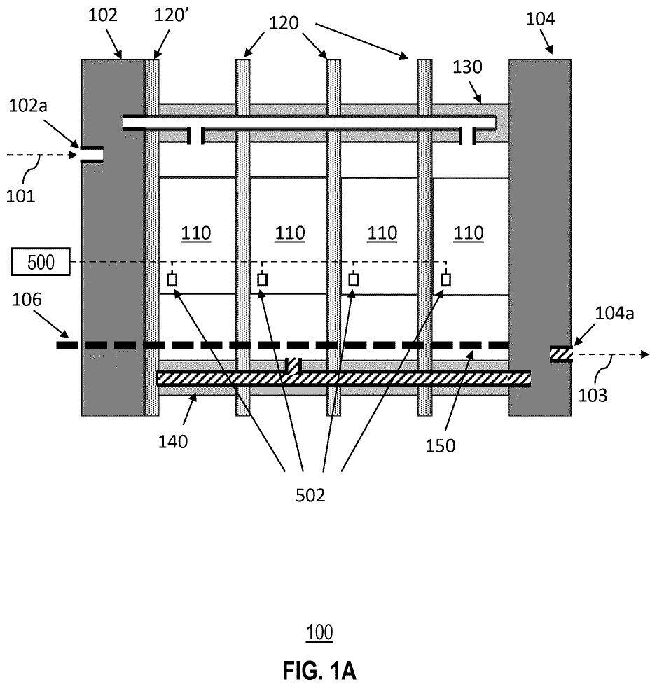

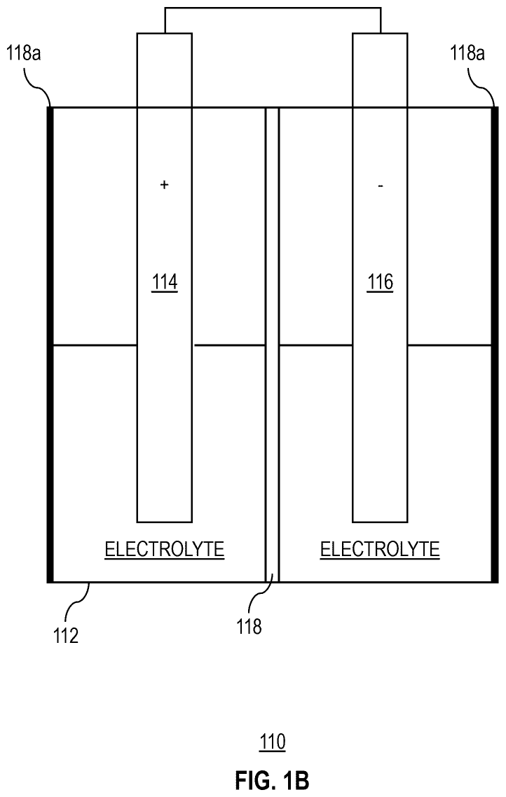

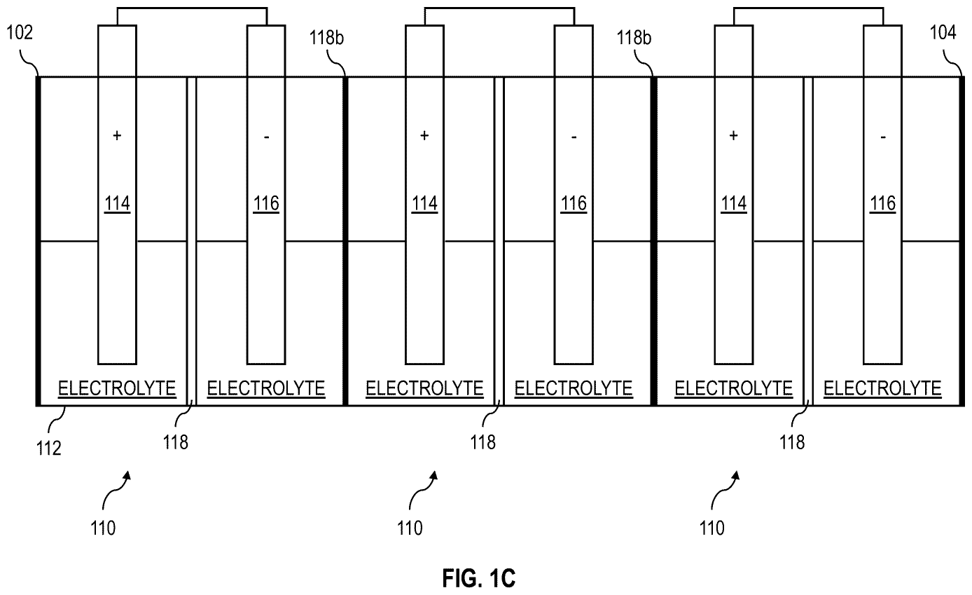

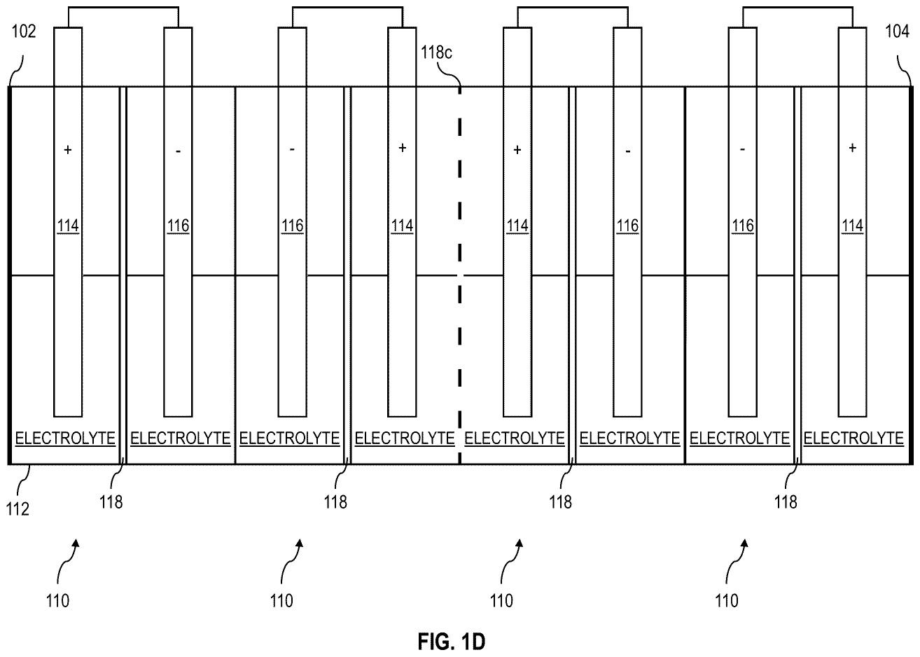

FIG. 1A is a schematic diagram of an example electrochemical cell assembly 100. An inlet fluid 101 can be flowed into the assembly 100. The assembly 100 houses an electrolyte. In some implementations, the inlet stream 101 flowed into the assembly 100 interacts with the electrolyte housed within the assembly 100 in a reduction-oxidation (redox) reaction, and the assembly 100 generates electrical power in response to the redox reaction. Examples of such implementations include a primary cell and a fuel cell. In some implementations, electrical power is supplied to the assembly 100, and the supplied electrical power drives the redox reaction involving the inlet stream 101 flowed into the assembly 100 and the electrolyte housed within the assembly 100 to produce a desired product. One example of such implementations is an electrolytic cell. In some implementations, the redox reaction occurring within the assembly 100 is a reversible electrochemical reaction that can switch between a charging mode (store energy) and a discharging mode (release energy). One example of such implementations is a secondary cell.

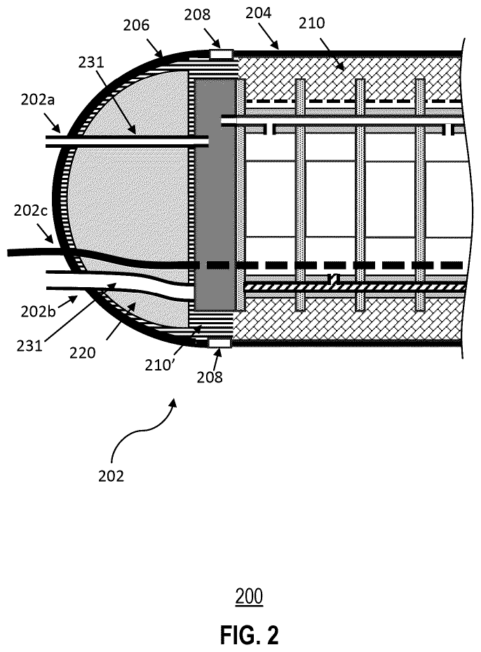

The assembly 100 includes a first end plate 102, a second end plate 104, and electrochemical cells 110. The end plates 102, 104 are the outermost components of the electrochemical cell stack. The end plates 102, 104 provide external electrical connections to the assembly 100 and minimize electrical resistive losses. In bipolar configurations, electricity is conducted predominantly in the direction across the plane of the cells 110 so that high surface are and thin thickness can contribute to low electrical losses. However, end plates 102, 104 require facilitating electrical connections to external conductors (for example, wires typically have much lower cross-sectional area on the order of magnitude of square millimeters in comparison to the area of the cell 110 which typically is on the order of magnitude of several square centimeters) and therefore should conduct comparatively higher electrical currents along the plane parallel to the electrochemical cells 110 (for example, toward the external conductors, such as wires). The end plates 102, 104 can, for example, be made of nickel, copper, or other conductive material with or without protective coating based on the requirements of a specific application. In some implementations, the end plates 102, 104 include fluid transport channels within their structures or in combination (e.g., at an interface) with a coupler (such as the coupler 220 shown in FIG. 2) via ports 102a and 104a, respectively. Such fluid transport channels can allow fluidic connection between manifolds (e.g., manifolds 130, 140) connected to the stack of cells 110 and housing ports (such as the ports 202a, 202b shown in FIG. 2). In some implementations, the end plates 102, 104 allow for temporary or permanent compression of the assembly 100 during manufacturing.

The electrochemical cells 110 are disposed between the first end plate 102 and second end plate 104. For each pair of neighboring electrochemical cells 110, the assembly 100 includes a separator 120 that is disposed between the respective pair of neighboring electrochemical cells 110. Depending on the specific application and cell configurations, each of the cells 110 (individually or as a part of the assembly 100) can include multiple types of separators 120. Although shown in FIG. 1A as including a single separator 120 between neighboring cells 110, the assembly 100 can include multiple separators 120 between neighboring cells 110. Further, the separators 120 can have different compositions and/or characteristics. The main function of the separators 120 is to prevent physical flow of at least one fluid between the positive electrode compartment, the negative electrode compartment, and the ion conducting medium compartment of a single cell 110 or assembly 100. As one example, the separator 120 can include solid metal plate(s) to restrict gas flow between the positive electrode compartment and the negative electrode compartment. As another example, the separator 120 can include ion permeable membrane(s) (e.g., Nafion™) to restrict flow of fluid between the positive electrode compartment and the ion conducting medium compartment. In this example, the separator 120 restricts fluid flow while also allowing for controlled fluid evaporation between compartments. The separators 120 can include an incompressible adhesive (an example is shown in FIG. 2, indicated as reference number 210) for sealing between individual separators 120 and/or to another surface (e.g., a surrounding cylindrical wall). The incompressible adhesive can be incorporate within itself other components of the assembly 100 (e.g., manifolds 130, 140). Incompressible additive(s) can be placed between the stack of electrochemical cells 110 and a surrounding surface (e.g., a cylindrical wall) which are incompressible (e.g., plastic, metal, or porous material with open pores) or form a hollowed structure in fluid communication with compartments of the stack of electrochemical cells 110 (e.g., gas/fluid channels in the manifold, such as flexible tubing). The incompressible additives can be included in the assembly 100 prior to, simultaneously with, or after application of the incompressible adhesive. For example, porous felts can be placed between the assembly 100 and a surrounding cylindrical wall prior to application of the incompressible adhesive while additives, such as powders and fibers, can be intermixed with the incompressible adhesive prior to application. In some implementations, the incompressible additives incorporated in the incompressible adhesive are used to improve mechanical strength, modify heat transfer (e.g., increase or decrease heat transfer), reduce volumetric cost of the incompressible adhesive, or any combinations of these. As one example, a porous heat resistant material can be placed between the assembly 100 and a cylindrical housing. Including such incompressible additives (e.g., porous heat resistant material) can thermally insulate the stack of cells 100 during assembly, for example, in cases where the housing is assembled by high temperature welding.

In some implementations, as shown in FIG. 1A, the assembly 100 includes an end separator 120′ that is disposed between the first end plate 102 and the electrochemical cell 110 that is located closest to the first end plate 102. The end separator 120′ can be in contact with the first end plate 102. The first and/or second end plates 102, 104 can be placed in contact with other components of the assembly 100 and act as a separator.

Each electrochemical cell 110 includes a pair of electrodes and an electrolyte. In some implementations, all the electrochemical cells 110 are substantially the same (e.g., same material of construction for electrodes and same electrolyte). In some implementations, the electrochemical cells 110 are different, for example, carry different electrolytes and/or have electrodes made of different materials. As described previously, each of the electrochemical cells 110 can generate electrical power in response to a chemical reaction (e.g., redox reaction) involving at least a portion of the inlet stream 101 and/or use electrical power to cause at least a portion of the inlet stream 101 to react. An example of the electrochemical cell 110 is shown in FIG. 1B and described in more detail later.

The electrochemical cells 110 convert one or more reactants of the inlet stream 101 into one or more products that end up in the outlet stream 103. The inlet stream 101 can include a gas, a liquid, a solid, or any combinations of these. The outlet stream 103 can include a gas, a liquid, a solid, or any combinations of these. During continuous operation, the cells 110 require constant supply of reactants and constant removal of products. In some cases, the cells 110 require constant supply of electrical power (e.g., electrolytic cell). Although shown in FIG. 1A as including four electrochemical cells 110, the assembly 100 can include fewer (for example, one, two, or three) or more (for example, five, six, or more than six) electrochemical cells 110. Regardless of the number of electrochemical cells 110 included in the assembly 100, all of the electrochemical cells 110 are sandwiched between the first end plate 102 and the second end plate 104. By integrating multiple electrochemical cells 110 into a single assembly 100, the assembly 100 combines the product output from all the electrochemical cells 110 while also combining the reactant consumption of all the electrochemical cells 110. As such, the assembly 100 is capable of integrating large quantities of reactants and products into a single reactants stream and a single products stream, respectively, which can be more easily managed in comparison to management of multiple smaller streams.

The first end plate 102 defines a first port 102a configured to receive the inlet stream 101. The first end plate 102 is hollow for receiving the inlet stream 101 via the first port 102a. The second end plate 104 defines a second port 104a. The second end plate 104 is hollow for holding and discharging an outlet stream 103 from the second end plate 104 via the second port 104a. At least one of the first end plate 102 or the second end plate 104 defines an electrical port 106 configured to transmit electrical power to or from the assembly 100. In some implementations, as shown in FIG. 1A, the first end plate 102 defines the electrical port 106. In some implementations, the second end plate 104 defines the electrical port 106. In some implementations, each of the first end plate 102 and the second end plate 104 define separate electrical ports 106. For example, a first electrical port defined by the first end plate 102 can be configured to connect to a positive terminal, and a second electrical port defined by the second end plate 104 can be configured to connect to a negative terminal. As another example, the first electrical port defined by the first end plate 102 can be configured to connect to the negative terminal, and the second electrical port defined by the second end plate 104 can be configured to connect to the positive terminal.

The assembly 100 includes a first flow manifold 130 that fluidically connects the first end plate 102 with each electrochemical cell 110 for flowing the inlet stream 101 from the first end plate 102 to each electrochemical cell 110. The assembly includes a second flow manifold 140 that fluidically connects the second end plate 104 with each electrochemical cell 110 for flowing the outlet stream 103 from each electrochemical cell 110 to the second end plate 104. In the specific example shown in FIG. 1A, the first flow manifold 130 can be considered the inlet manifold, and the second flow manifold 140 can be considered the outlet manifold.

The first flow manifold 130 can include multiple pipes, tubes, chambers, conduits, channels, or any combinations of these, each of which can be configured to be fluidically connected to a corresponding inlet or outlet for each distinct fluid entering the electrochemical cells 110. Similarly, the second flow manifold 140 can include multiple pipes, tubes, chambers, conduits, channels, or any combinations of these, each of which can be configured to be fluidically connected to a corresponding inlet or outlet for each distinct fluid exiting the electrochemical cells 110. Any of the first or second flow manifolds 130, 140 can be unitary bodies or modular and formed by connection of individual parts. The first and second flow manifolds 130, 140 can be formed with an incompressible adhesive (e.g., the adhesive 210 shown in FIG. 2). A formwork (e.g., formed by connection of individual parts) can be used to define the resulting shape of the incompressible adhesive (similar to formworks used in construction to form concrete into structural shapes). The first and second flow manifolds 130, 140 can provide mechanical support to the first and second end plates 102, 104. For example, the first and second flow manifolds 130, 140 can provide compressive strength and/or tensile strength. In some implementations, the first flow manifold 130, the second flow manifold 140, or both are assembled by joints. Some examples of joints include a snap-fit joint, a bolted joint, an adhesive joint, an interlocking joint, a welded joint, a riveted joint, and a threaded joint.

In various electrochemical processes, introducing two or more distinct streams into an electrochemical cell (such as the electrochemical cell 110) can result in accumulation of contaminants within the cell. Such accumulation may occur due to gas crossover, in which gas on one side of the inter-electrode separator migrates to the other side (e.g., from the cathode side to the anode side, or from the anode side to the cathode side), resulting in contamination. Gas crossover can accumulate contamination over time. Disengagement of the electrical power connection for halting operation may also result in accumulation of contamination. Contamination accumulation can negatively require a full shutdown, in which the electrochemical cell is purged, for example, with an inert gas. Startup after the purging process typically require full startup procedures before resuming operation.

In some implementations, the first flow manifold 130 includes multiple designated flowlines that each connect to the electrochemical cells 110, where each flowline is designated for a distinct inlet fluid (feed). In some implementations, the second flow manifold 140 includes multiple designated flowlines that each connect to the electrochemical cells 110, where each flowline is designated for a distinct outlet fluid. The first and second flow manifolds 130, 140 provide the assembly 100 capability of circulating or re-circulating streams through one or more of the electrochemical cells 110. This can be advantageous, for example, in cases where it is desired to maintain a paused state in which one or more electrochemical cells 110 are not operating but remain available for immediate startup without needing to perform preparation steps that are typical for startup procedures. For example, the first and second flow manifolds 130, 140 can be used to continuously or periodically recirculate the bulk gas bodies from the electrochemical cells 110 through an external device that removes contaminants (e.g., a filter or absorption bed). As another example, the first and second flow manifolds 130, 140 can be used to consistently remove oxygen from hydrogen (or remove hydrogen from oxygen), thereby maintaining safe operation even after electrical power has been disengaged from the cells 110.

The assembly 100 includes an electrical manifold 150 that electrically connects the electrical port 106 to the electrodes of the electrochemical cells 110 for transmitting electrical power between the electrical port 106 and the electrodes of the electrochemical cells 110. The electrical manifold 150 can include electrical power connections, wiring, or both. In some implementations, the electrical manifold 150 cumulatively transmits electrical power to/from the electrochemical cells 110. In some implementations, the electrical manifold 150 transmits electrical power individually to/from each electrochemical cell 110. In some implementations, the electrodes of the electrochemical cells 110 are electrically connected by the electrical manifold 150 in a series configuration. In some implementations, the electrodes of the electrochemical cells 110 are electrically connected by the electrical manifold 150 in a parallel configuration. In some implementations, the electrodes of the electrochemical cells 110 are electrically connected by the electrical manifold 150 in a combination of a series configuration and a parallel configuration. In some implementations, the electrical manifold 150 is omitted. For example, bipolar cell assemblies do not require the use of the electrical manifold 150 because electrical current can be predominantly transmitted across the cell plane (an example is shown in FIG. 1C). In other examples, the electrical manifold 150 is included when electrical current is predominantly transmitted along the electrode plane (an example is shown in FIG. 1D).

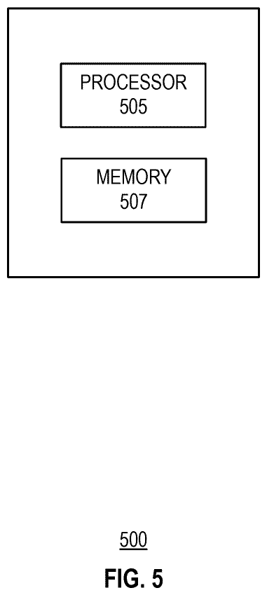

In some implementations, each electrochemical cell 110 includes an attached computer chip 502. Each computer chip 502 can, for example, be embedded in a frame of the respective electrochemical cell 110. Each computer chip 502 is electrically connected to each electrode of the respective electrochemical cell 110, for example, by a short, highly resistive wire. In some implementations, the computer chips 502 are electrically connected to one another. In some implementations, the assembly 100 includes a main controller 500. In some implementations, the computer chips 502 are electrically connected to the main controller 500 by a common wire. By connecting the computer chips 502 to the main controller 500 by a common wire, utilizing many separate wires can be avoided. In some implementations, the computer chips 502 can transmit data independent of physical connections (e.g., wirelessly). Each computer chip 502 can, for example, transmit a voltage signal to the main controller 500, representing a voltage across the electrodes of the respective electrochemical cell 110. Other examples of data that the computer chips 502 can transmit include temperature data, ion conducting medium property data (e.g., concentrations of ions in electrolyte, ionic strength, water content, and pressure), and positive and negative electrode fluid property data (e.g., gas composition, pressure, humidity, fluid content, and fluid velocity). An example of the main controller 500 is shown in FIG. 5 and described in more detail later.

FIG. 1B is a schematic diagram of an example electrochemical cell 110. The electrochemical cell 110 includes a frame 112, a positive electrode 114, a negative electrode 116, and a separator 118. The separator 118 segments the frame 112 into an positive compartment and a negative compartment. The separator 118 can, for example, be an ion conducting separator (membrane) having a composite structure. The separator 118 can provide ion conductivity. In some implementations, the separator 118 can prevent flow of gas and/or liquid from migrating to/from the anode/cathode sides. In some implementations (e.g., when an ion conductive medium such as a liquid electrolyte is used within the separator 118), the separator 118 can separate gas and/or liquid contained within or circulated through the separator 118 from gas and/or liquid present in the anode/cathode sides. The positive electrode 114 resides in the positive compartment, and the negative electrode 116 resides in the negative compartment. The positive electrode 114 and negative electrode 116 are in contact with an electrolyte. In some implementations, the positive electrode 114 and negative electrode 116 are immersed in an electrolyte solution. In some implementations, the separator 118 is the electrolyte, as in the case with proton-exchange membrane fuel cells. In some implementations, the electrolyte on the positive compartment is the same as the electrolyte on the negative compartment. In some implementations, the electrolyte on the positive compartment is different from the electrolyte on the negative compartment. In cases where the electrochemical cell 110 is, for example, a voltaic/galvanic cell or a fuel cell, chemical reactions occurring within the cell 110 establish a difference in charge, thereby generating electrical power. In cases where the electrochemical cell 110 is, for example, an electrolytic cell, electrical power is supplied to the electrochemical cell 110 to establish a difference in charge, thereby providing electrical energy to produce a chemical reaction which would not occur spontaneously otherwise. The separators 118a separate the cell 110 from a neighboring cell for preventing gas and/or liquid from flowing to the neighboring cell. In some implementations, the separators 118a provide electrical connections to the electrodes 114, 116. The separators 118a can be implementations of the separator 120 shown in FIG. 1A.

In some implementations, as shown in FIG. 1B, the separators 118a can act as end plates (similar to end plates 102, 104). In some implementations, the separators 118a have a different structure from the end plates 102, 104. For example, the end plates 102, 104 can have a larger thickness and/or be made of a material exhibiting higher electrical conductivity in comparison to the separators 118a for allowing a lower sheet resistance across the plates 102, 104. The separators 118a can, for example, be made of steel alloy including a protective coating. Some examples of suitable materials include nickel, copper, or other conductive material with or without protective coating, based on the requirements of a specific application.

FIG. 1C is a schematic diagram of multiple neighboring electrochemical cells 110. Each electrochemical cell 110 in this configuration is separated from a neighboring electrochemical cell 110 by a separator 118b, which can be an implementation of the separator 118a shown in FIG. 1B or an implementation of the separator 120 shown in FIG. 1A. The separators 118b separate neighboring cells 110 for preventing gas and/or liquid from flowing between neighboring cells 110. In some implementations, the separators 118b provide electrical connections to the electrodes 114, 116. In some implementations, as shown in FIG. 1C, the electrochemical cells 100 are sandwiched between end plates 102, 104. In some implementations, the end plates 102, 104 shown in FIG. 1C can be replaced by implementations of the separator 120 shown in FIG. 1A, the separator 118a shown in FIG. 1B, or the separator 118b.

FIG. 1D is a schematic diagram of multiple neighboring electrochemical cells 110. In contrast to the configuration shown in FIG. 1C, the configuration shown in FIG. 1D has the same charged sides of neighboring electrochemical cells 110 to be next to one another. For example, the anode sides of neighboring electrochemical cells 110 are adjacent, while the cathode sides of neighboring electrochemical cells 110 are adjacent. Element 118c is disposed between positive compartments of neighboring electrochemical cells 110 for electrically isolating the positive compartments of neighboring electrochemical cells 110. However, element 118c allows fluid to flow between the positive compartments of neighboring electrochemical cells 110.

FIG. 2 is a schematic diagram of an example electrochemical cell system 200. During operation of the electrochemical cell assembly 100, the electrochemical cells 110 should be able to physically withstand the pressure difference between the inside and the outside of the cells 110. Conventional electrochemical cells may typically require strong and thick external walls, depending on the extent of this pressure difference. However, it is typically complex and demanding to assemble electrochemical cells of this type to handle and maintain the pressure difference. It can be extremely challenging, if not impossible in many cases, to assemble such electrochemical cells with acceptable reliability for use in high speed, high volume industrial manufacturing processes.

This challenge can be avoided by incorporating the electrochemical cell assembly 100 (including the electrochemical cells 110) into a housing 202. The housing 202 can include a cylindrical wall 204, end caps 206, and couplings 208. The couplings 208 couple the end caps 206 to the cylindrical wall 204. The couplings 208 can, for example, a snap-fit joint, a bolted joint, an adhesive joint, an interlocking joint, a welded joint, a riveted joint, or a threaded joint. An annular space defined between the electrochemical cells 110 and the cylindrical wall 204 of the housing 202 can be at least partially filled (e.g., substantially fully filled) with an incompressible adhesive 210. In cases where the separators (120, 120′) extend past the electrochemical cells 110, as shown in FIG. 2, the incompressible adhesive 210 can at least partially fill the space between neighboring separators (120, 120′). The electrochemical cells 110 are surrounded by the incompressible adhesive 210. The incompressible adhesive 210 is configured to hermetically seal the electrochemical cells 110 within the housing 202, such that the electrochemical cells 110 are prevented from exposure to pressure that is external to the incompressible adhesive 210. Some examples of incompressible adhesives 210 include silicon-based adhesives, acrylic-based adhesives, polymers, solvent-based adhesives, hot melts, and epoxies (such as epoxies including a silane coupling agent, a silyl-terminated polyether, or sodium silicate). The incompressible adhesive 210 can begin as a liquid that then hardens into solid after being placed in the annular space between the assembly 100 and the housing 202. In some implementations, the incompressible adhesive 210 can be reversibly hardened (that is, can be softened after being hardened), as is the case with thermoplastics (e.g., hot melt). In some implementations, the incompressible adhesive 210 is irreversibly hardened, as is the case with thermosets. By beginning as a liquid, the incompressible adhesive 210 can be easily placed and at least partially fill the annular space between the assembly 100 and the housing 202. Once placed in the desired location(s) within the housing 202, the incompressible adhesive 210 can be hardened (for example, by cooling, curing, cross-linking, or any combinations of these) to establish the hermetic seal. In some implementations, the incompressible adhesive 210 is capable of withstanding an external-to-internal pressure differential that is less than about 200 kilopascals (kPa), less than about 100 kPa, less than about 75 kPa, less than about 50 kPa, less than about 20 kPa, or less than about 10 kPa. In some implementations, the incompressible adhesive 210 is capable of withstanding an external-to-internal pressure differential in a range from about 10 kPa to about 200 kPa, from about 10 kPa to about 100 kPa, from about 10 kPa to about 75 kPa, from about 10 kPa to about 50 kPa, from about 10 kPa to about 20 kPa, from about 20 kPa to about 200 kPa, from about 50 kPa to about 200 kPa, from about 75 kPa to about 200 kPa, from about 100 kPa to about 200 kPa, from about 20 kPa to about 100 kPa, from about 20 kPa to about 75 kPa, from about 20 kPa to about 50 kPa, from about 50 kPa to about 100 kPa, or from about 50 kPa to about 75 kPa. In some implementations, a porous heat resistant material is placed between the assembly 100 and coupling 208 prior to application of the incompressible adhesive 210 and assembly of the coupling 208, which can thermally insulate the stack of electrochemical cells 110 during assembly (for example, in cases where the coupling 208 is formed by high temperature welding).

The housing 202 defines a housing inlet port 202a, a housing outlet port 202b, and a housing electrical port 202c. The housing inlet port 202a is fluidically connected to the inlet port 102a of the assembly 100. The housing outlet port 202b is fluidically connected to the outlet port 104a of the assembly 100. The housing electrical port 202c is electrically connected to the electrical port 106 of the assembly 100. In some implementations, as shown in FIG. 2, the system 200 can include an incompressible coupler 220 that includes a fluidic connection between the housing inlet port 202a and the inlet port 102a, a fluidic connection between the housing outlet port 202b and the outlet port 104a, and an electrical connection between the housing electrical port 202c and the electrical port 106. The incompressible coupler 220 can be made of, for example, plastic, metal, glass, ceramic, carbon fiber, or any combinations of these. The incompressible coupler 220 enables fluidic connection between manifolds of the system 200, inlet ports (e.g., inlet port 202a), and outlet ports (e.g., outlet port 202b). In some implementations, the coupler 220 and another component of the system 200 (e.g., end plate 102) are cooperatively configured to provide such fluidic connections. In some implementations, the coupler 220 fluidically interconnects, by conduits 231, the manifolds of the system 200 (e.g., manifolds 130, 140). In some implementations, the coupler 220 houses and hermetically seals electrical connections (e.g., via electrical port 202c) to fluid handling equipment (e.g., fans, blowers, and pumps) that assist in fluid transport to, from, and throughout the system 200 via the ports 202a, 202b. By providing a hermetic seal and housing, the coupler 220 can transport pressurized fluids throughout the system 200, as well as between housing ports (202a, 202b) and the system 200, by use of fluid handling equipment that do not require to be designed to withstand significant internal pressures that may exist in the manifolds (e.g., 130, 140). That is, the coupler 220 can protect components housed within the coupler 220 from being exposed to high pressure differences between internally flowing fluid and an external environment. The coupler 220 can therefore increase mass transfer efficiency and reduce gravimetric and volumetric requirements of fluid handling equipment. In some implementations, the coupler 220 allows for temporary or permanent compression of the assembly 100, as the system 200 is assembled (for example, by use of tie rods).

In some implementations, a remaining inner volume of the housing 202 can be filled with an incompressible adhesive 210′ for additional hermetically sealing and providing additional structural support to the system 200. In some implementations, the incompressible adhesive 210′ has the same composition as the incompressible adhesive 210. In some implementations, the incompressible adhesive 210′ has a different composition from the incompressible adhesive 210.

Surrounding the electrochemical cells 110 with the incompressible adhesive 210 eliminates the need for the electrochemical cells 110 to have strong and thick external walls because of the hermetical sealing provided by the incompressible adhesive 210. The hermetical sealing provided by the incompressible adhesive 210 ensures that a minimal pressure difference exists between the inside and outside of the electrochemical cells 110, thereby allowing the use of simpler designs of the electrochemical cells 110 which can be more readily combined into the assemblies 100 in comparison to conventional electrochemical cells, including in high speed, high volume industrial manufacturing processes. The system 200 can therefore be used in high speed, high volume industrial manufacturing and production of electrochemical cell assemblies 100 that can, for example, be used to produce or consume gases having high absolute pressures (e.g., between about 500 kilopascals (kPa) to about 2,500 bar) or very high absolute pressures (e.g., between about 2,500 kPa to about 10,000 kPa). The system 200 can be designed for use in high speed, high volume industrial manufacturing and production of electrochemical cell assemblies 100 that can, for example, be used to produce or consume gases having operating pressures in a range from about 1,500 kPa to about 2,500 kPa or greater.

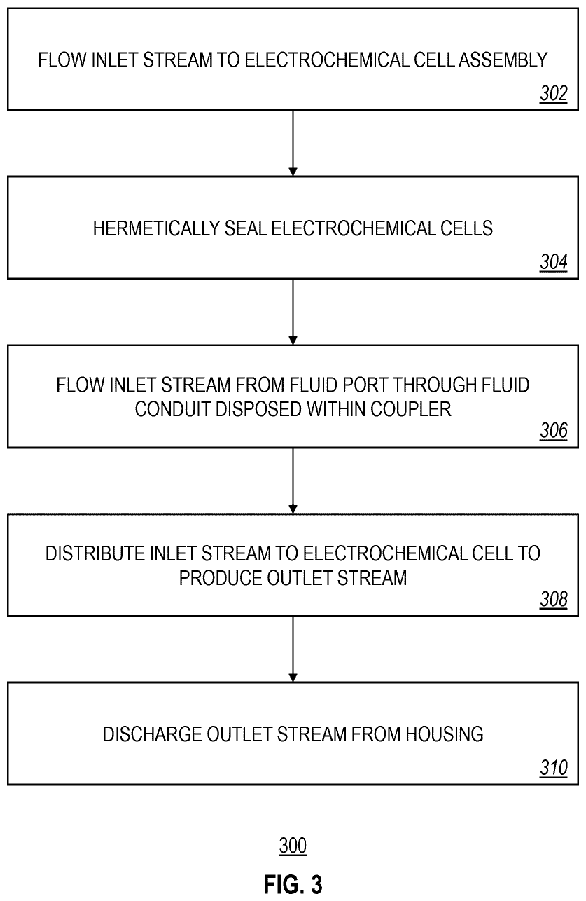

FIG. 3 is a flow chart of an example method 300 of operating an electrochemical cell system, such as the electrochemical cell system 200. At block 302, an inlet stream (such as the inlet stream 101) is flowed to an electrochemical cell assembly (such as the electrochemical cell assembly 100). For example, the inlet stream 101 is flowed into the fluid port 202a at block 302. At block 304, the incompressible adhesive 210 surrounding the electrochemical cells 110 of the electrochemical cell assembly 100 hermetically seals the electrochemical cells 110 to prevent the electrochemical cells 110 from being exposed to pressure that is external to the incompressible adhesive 210. At block 306, the inlet stream 101 is flowed from the fluid port 202a through a fluid conduit (such as the fluid conduit 231) disposed within a coupler (such as the coupler 220) disposed within a housing (such as the housing 202). At block 308, a flow manifold (such as the first flow manifold 130) distributes the inlet stream 101 to at least one of the electrochemical cells 110. The inlet stream 101 interacts with the electrolyte of the electrochemical cell 110 in a redox reaction and produces an outlet stream (such as the outlet stream 103). At block 310, the outlet stream 103 is discharged from the housing 202. For example, in cases where the housing 202 defines an outlet port (such as the outlet port 202b), the outlet stream 103 is discharged from the outlet port 202b of the housing 202 at block 310. As another example, in cases where the fluid port 202a is a bidirectional port, the outlet stream 103 is discharged from the outlet port 202a of the housing 202 at block 310.

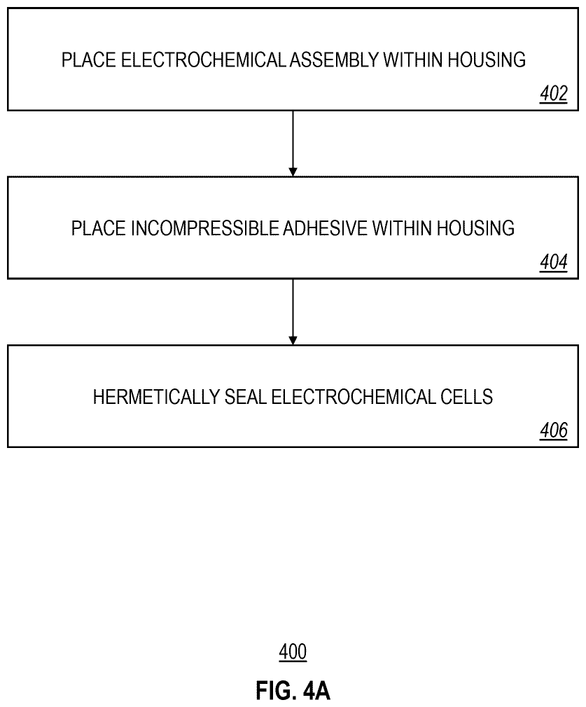

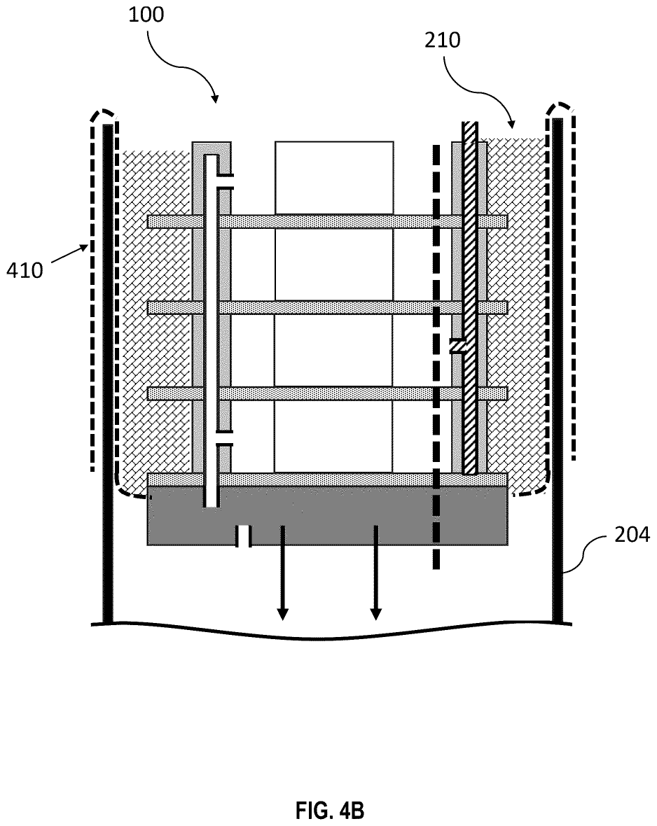

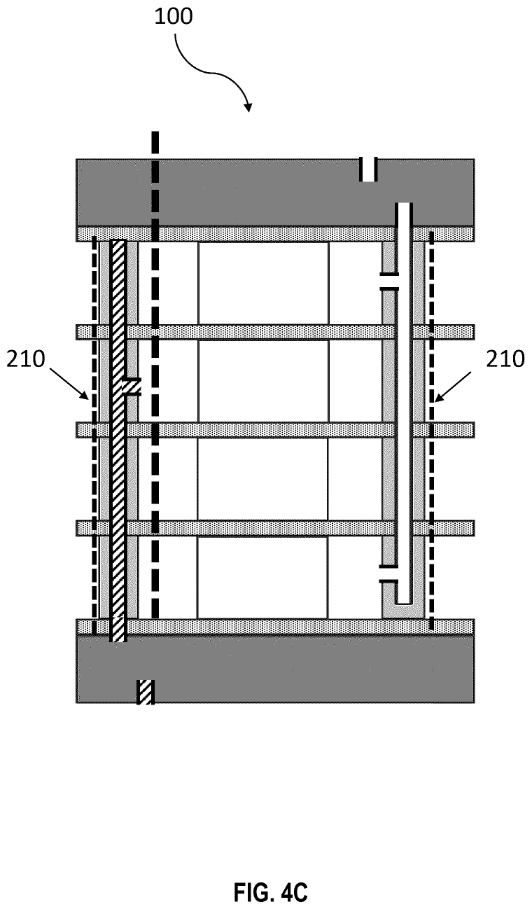

FIG. 4A is a flow chart of an example method 400 of producing an electrochemical cell system, such as the electrochemical cell systems 200. At block 402, an electrochemical cell assembly (such as the assembly 100) is placed within a housing (such as the housing 202). At block 404, an incompressible adhesive (such as the incompressible adhesive 210) is placed within the housing 202. The incompressible adhesive 210 is placed within the housing 202 at block 404, such that an annular space defined between the electrochemical cells 110 and the housing 202 is at least partially filled with the incompressible adhesive 210, and the electrochemical cells 110 are surrounded by the incompressible adhesive 210. At block 406, the incompressible adhesive 210 surrounding the electrochemical cells 110 of the electrochemical cell assembly 100 hermetically seals the electrochemical cells 110 to prevent the electrochemical cells 110 from being exposed to pressure that is external to the incompressible adhesive 210.

In some implementations, the incompressible adhesive 210 is placed within the housing 202 at block 404 while the electrochemical cell assembly 100 is placed within the housing 202 at block 402. For example, the incompressible adhesive 210 can be continuously applied in the annular space between the assembly 100 and the cylindrical wall 204 of the housing 202 as the assembly 100 is being placed within the housing 202.

In some implementations, the assembly 100 is wrapped with a polymer sleeve 410 prior to being placed within the housing 202 at block 402. An example is shown in FIG. 4B, which is schematic diagram of an example of the electrochemical cell assembly 100 wrapped with the polymer sleeve 410. In such implementations, the assembly 100 wrapped with the polymer sleeve 410 is placed within the housing 202 at block 402. The space between the polymer sleeve 410 and the assembly 100 can be at least partially filled with the incompressible adhesive 210. In such implementations, the incompressible adhesive 210 is placed within the housing 202 at block 404 simultaneously as the assembly 100 is placed within the housing 202 at block 402. In some implementations, the internal components of the system 200 are fully assembled prior to placement within the housing 202 at block 402. For example, if the coupler 220 is used to provide temporary/permanent compressive strength to the assembly 100, the internal components of the system 200 can be fully assembled prior to placement within the housing 202 at block 402. The polymer sleeve 410 can, for example, be made of polyethylene, polypropylene, polyvinyl chloride, or any combinations of these. In some implementations, the polymer sleeve 410 has a non-zero thickness less than about 500 micrometers (μm), less than about 200 μm, less than about 100 μm, less than about 50 μm, or less than about 10 μm. In some implementations, the polymer sleeve 230 has a thickness in a range of from about 10 μm to about 500 μm, from about 50 μm to about 500 μm, from about 100 μm to about 500 μm, from about 200 μm to about 500 μm, from about 10 μm to about 200 μm, from about 10 μm to about 100 μm, from about 10 μm to about 50 μm, from about 50 μm to about 200 μm, from about 50 μm to about 100 μm, or from about 100 μm to about 200 μm. The incompressible adhesive 210 provides a seal between components and manifolds of the system 200. The incompressible adhesive 210 can be applied independent of external pressure, for example, by only relying on gravitational force, such that deep penetration of the incompressible adhesive 210 into a relevant compartment of the cell 110 can be avoided. Once the assembly 100 wrapped with the polymer sleeve 410 and surrounded by the incompressible adhesive 210 is placed within the cylindrical wall 204, the ports (102a, 104a, 106) of the assembly 100 can be connected to the housing ports (202a, 202b, 202c, respectively) via the coupler 220. Gas can be evacuated from the housing 202 (for example, by a vacuum pump), and additional incompressible adhesive 210 can be injected into the housing 202 to substantially fill a remaining inner volume of the housing 202. In some implementations, gas is evacuated from the housing 202 and other components of the system 200. The incompressible adhesive 210 can be supplied at a controlled differential pressure in relation to the pressure of the gas within the system 200 to avoid damage of the seal provided by the incompressible adhesive 210 and to avoid deep penetration of the incompressible adhesive 210 into relevant compartment(s) of the cell(s) 110. For example, if the pressure of the gas is maintained at the same level of pressure in the overhead gas space of the incompressible adhesive 210 and within the housing 202 and relevant compartment(s) of the cell(s) 110, the incompressible adhesive 210 can be supplied at a controlled pressure by varying elevation between the incompressible adhesive 210 within the container supplying the incompressible adhesive 210 and the housing 202.

In some implementations, the incompressible adhesive 210 is applied to an external surface of the assembly 100 (e.g., covering external surfaces of the electrochemical cells 110) prior to placing the assembly 100 within the housing 202. An example is shown in FIG. 4C, which is a schematic diagram of an example of the electrochemical cell assembly 100 at least partially covered with the incompressible adhesive 210. In such implementations, the incompressible adhesive 210 is placed within the housing 202 at block 404 simultaneously as the assembly 100 is placed within the housing 202 at block 402. Although shown in FIG. 4C as a thin layer, the incompressible adhesive 210 can be applied as a thicker layer, as long as the outer diameter of the assembly 100 including the applied incompressible adhesive 210 is less than the inner diameter of the cylindrical wall 204, so that the assembly 100 including the applied incompressible adhesive 210 can fit within the inner bore of the cylindrical wall 204. Once the assembly 100 at least partially surrounded by the incompressible adhesive 210 is placed within the cylindrical wall 204, the ports (102a, 104a, 106) of the assembly 100 can be connected to the housing ports (202a, 202b, 202c, respectively) via the coupler 220. Gas can be evacuated from the housing 202 (for example, by a vacuum pump), and additional incompressible adhesive 210 can be injected into the housing 202 to substantially fill a remaining inner volume of the housing 202.

FIG. 5 is a block diagram of an example controller 500 used to provide computational functionalities associated with described algorithms, methods, functions, processes, flows, and procedures, as described in this specification, according to an implementation. The illustrated controller 500 is intended to encompass any computing device such as a server, desktop computer, laptop/notebook computer, one or more processors within these devices, or any other processing device, including physical or virtual instances (or both) of the computing device. Additionally, the controller 500 can include a computer that includes an input device, such as a keypad, keyboard, touch screen, or other device that can accept user information, and an output device that conveys information associated with the operation of the controller 500, including digital data, visual, audio information, or a combination of information. The computer chip 502 shown in FIG. 1A can, for example, be an implementation of the controller 500.

The controller 500 includes a processor 505. The processor 505 may be a microprocessor, a multi-core processor, a multithreaded processor, an ultra-low-voltage processor, an embedded processor, or a virtual processor. In some embodiments, the processor 505 may be part of a system-on-a-chip (SoC) in which the processor 505 and the other components of the controller 502 are formed into a single integrated electronics package. In some implementations, the processor 505 may include processors from Intel® Corporation of Santa Clara, California, from Advanced Micro Devices, Inc. (AMD) of Sunnyvale, California, or from ARM Holdings, LTD., Of Cambridge, England. Any number of other processors from other suppliers may also be used. Although illustrated as a single processor 505 in FIG. 5, two or more processors may be used according to particular needs, desires, or particular implementations of the controller 500. Generally, the processor 505 executes instructions and manipulates data to perform the operations of the controller 502 and any algorithms, methods, functions, processes, flows, and procedures as described in this specification. The processor 505 may communicate with other components of the controller 500 over a bus. The bus may include any number of technologies, such as industry standard architecture (ISA), extended ISA (EISA), peripheral component interconnect (PCI), peripheral component interconnect extended (PCIx), PCI express (PCIe), or any number of other technologies. The bus may be a proprietary bus, for example, used in an SoC based system. Other bus technologies may be used, in addition to, or instead of, the technologies above.

The controller 500 also includes a memory 507 that can hold data for the controller 500 or other components (or a combination of both) that can be connected to the network. Although illustrated as a single memory 507 in FIG. 5, two or more memories 507 (of the same or combination of types) can be used according to particular needs, desires, or particular implementations of the controller 500 and the described functionality. While memory 507 is illustrated as an integral component of the controller 500, memory 507 can be external to the controller 500. The memory 507 can be a transitory or non-transitory storage medium. In some implementations, such as in PLCs and other process control units, the memory 507 is integrated with a database used for long-term storage of programs and data. The memory 507 can include any number of volatile and nonvolatile memory devices, such as volatile random-access memory (RAM), static random-access memory (SRAM), flash memory, and the like. In smaller devices, such as PLCs, the memory 507 may include registers associated with the processor 505 itself.

The memory 507 stores computer-readable instructions executable by the processor 605 that, when executed, cause the processor 505 to perform operations, such as receive and process the transmitted voltage signals from the computer chips 502 of the electrochemical cells 110. The controller 500 can also include a power supply. The power supply can include a rechargeable or non-rechargeable battery that can be configured to be either user-or non-user-replaceable. The power supply can be hard-wired. There may be any number of computers 500 associated with, or external to, a computer system containing controller 500, each controller 500 communicating over the network. Further, the term “client,” “user,” “operator,” and other appropriate terminology may be used interchangeably, as appropriate, without departing from this specification. Moreover, this specification contemplates that many users may use one controller 500, or that one user may use multiple computers 500.

### Flow Control

In each of the configurations described, process streams (also referred to as “streams”) can be flowed using one or more flow control systems implemented throughout as assembly (e.g., assembly 100) or system (e.g., system 200, 300A, or 300B). A flow control system can include one or more flow pumps, blowers, or compressors to provide flow of the process streams, one or more flow pipes through which the process streams are flowed, and one or more valves to regulate the flow of streams through the pipes.

In some implementations, a flow control system can be operated manually. For example, an operator can set a flow rate for each pump, compressor, or blower by changing the position of a valve (open, partially open, or closed) to regulate the flow of the process streams through the pipes in the flow control system. Once the operator has set the flow rates and the valve positions for all flow control systems distributed across the gas processing plant, the flow control system can flow the streams within a unit or between units under constant flow conditions, for example, constant volumetric or mass flow rates. To change the flow conditions, the operator can manually operate the flow control system, for example, by changing the valve position.

In some implementations, a flow control system can be operated automatically. For example, the flow control system can be connected to a computer system to operate the flow control system. The computer system can include a computer-readable medium storing instructions (such as flow control instructions) executable by one or more processors to perform operations (such as flow control operations). For example, an operator can set the flow rates by setting the valve positions for all flow control systems distributed across the gas processing plant using the computer system. In such implementations, the operator can manually change the flow conditions by providing inputs through the computer system. In such implementations, the computer system can automatically (that is, without manual intervention) control one or more of the flow control systems, for example, using feedback systems implemented in one or more units and connected to the computer system. For example, a sensor (such as a pressure sensor or temperature sensor) can be connected to a pipe through which a process stream flows. The sensor can monitor and provide a flow conditions (such as a pressure or temperature) of the process stream to the computer system. In response to the flow condition deviating from a set point (such as a target pressure value or target temperature value) or exceeding a threshold (such as a threshold pressure value or threshold temperature value), the computer system can automatically perform operations. For example, if the pressure or temperature in the pipe exceeds the threshold pressure value or the threshold temperature value, respectively, the computer system can provide a signal to open a valve to relieve pressure or a signal to shut down process stream flow.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

### EMBODIMENTS

In an example implementation (or aspect), an electrochemical cell assembly comprises: a first separator; a second separator, wherein the first separator and the second separator define a fluid compartment of an electrochemical cell between the first separator and the second separator, wherein the fluid compartment has a positive compartment and a negative compartment; a positive electrode within the positive compartment; a negative electrode within the negative compartment; a housing defining a fluid port, a first electrical port, and a second electrical port; a flow manifold in fluid communication with the fluid compartment; a coupler comprising: a fluid conduit for fluid communication between the fluid port and the flow manifold; a first electrical conduit electrically connecting the first electrical port to the positive electrode; and a second electrical conduit electrically connecting the second electrical port to the negative electrode; and an incompressible adhesive disposed between the electrochemical cell and the housing.

In an example implementation (or aspect) combinable with any other example implementation (or aspect), the electrochemical cell assembly comprises a plurality of electrochemical cells.

In an example implementation (or aspect) combinable with any other example implementation (or aspect), the flow manifold comprises a plurality of designated flow lines.

In an example implementation (or aspect) combinable with any other example implementation (or aspect), each designated flow line is connected to each electrochemical cell.

In an example implementation (or aspect) combinable with any other example implementation (or aspect), each designated flow line is designated for a distinct feed.

In an example implementation (or aspect) combinable with any other example implementation (or aspect), each electrochemical cell comprises a frame within which the respective electrolyte is disposed and a computer chip embedded in the frame.

In an example implementation (or aspect) combinable with any other example implementation (or aspect), the electrochemical cell assembly comprises a controller communicatively coupled to each computer chip.

In an example implementation (or aspect) combinable with any other example implementation (or aspect), each computer chip is configured to transmit a voltage signal to the controller representing a voltage of the respective electrochemical cell. the controller is communicatively connected to each computer chip by a common wire.

In an example implementation (or aspect) combinable with any other example implementation (or aspect), the electrodes of the plurality of electrochemical cells are electrically connected in a series configuration.

In an example implementation (or aspect) combinable with any other example implementation (or aspect), an electrical manifold electrically connected to the first electrical conduit, the second electrical conduit, and each of the plurality of electrochemical cells.

In an example implementation (or aspect) combinable with any other example implementation (or aspect), the electrodes of the plurality of electrochemical cells are electrically connected in a parallel configuration by the electrical manifold.

In an example implementation (or aspect) combinable with any other example implementation (or aspect), an annular space defined between the plurality of electrochemical cells and the housing is at least partially filled with the incompressible adhesive.

In an example implementation (or aspect) combinable with any other example implementation (or aspect), the plurality of electrochemical cells are surrounded by the incompressible adhesive, and the incompressible adhesive is configured to hermetically seal the plurality of electrochemical cells within the housing, such that the plurality of electrochemical cells are prevented from exposure to pressure that is external to the incompressible adhesive.

In an example implementation (or aspect), a method comprises: flowing an inlet stream to an electrochemical cell assembly comprising a plurality of electrochemical cells disposed within a housing defining a fluid port, a first electrical port, and a second electrical port, wherein the inlet stream is flowed into the fluid port of the housing; hermetically sealing, by an incompressible adhesive, the plurality of electrochemical cells within the housing to prevent the plurality of electrochemical cells from being exposed to pressure that is external to the incompressible adhesive; flowing the inlet stream from the fluid port through a fluid conduit disposed within a coupler disposed within the housing; distributing, by a flow manifold in fluid communication with the fluid conduit, the inlet stream to at least one of the plurality of electrochemical cells, wherein the inlet stream interacts with an electrolyte of the at least one of the plurality of electrochemical cells in a reduction-oxidation reaction to produce an outlet stream; and discharging the outlet stream from the housing.

In an example implementation (or aspect) combinable with any other example implementation (or aspect), the method comprises transmitting, by the first electrical port, electrical power through a first electrical conduit disposed within the coupler to the at least one of the plurality of electrochemical cells, thereby causing the reduction-oxidation reaction involving the inlet stream and the electrolyte of the at least one of the plurality of electrochemical cells to occur.

In an example implementation (or aspect) combinable with any other example implementation (or aspect), the method comprises generating, by each electrochemical cell, electrical power in response to the reduction-oxidation reaction involving the inlet stream and the electrolyte of the respective electrochemical cell.

In an example implementation (or aspect) combinable with any other example implementation (or aspect), the method comprises transmitting, by the second electrical conduit, the generated electrical power from each electrochemical cell.

In an example implementation (or aspect) combinable with any other example implementation (or aspect), each electrochemical cell comprises a frame within which the respective electrolyte is disposed and a computer chip embedded in the frame.

In an example implementation (or aspect) combinable with any other example implementation (or aspect), the method comprises transmitting, by each computer chip, a voltage signal representing a voltage of the respective electrochemical cell.

In an example implementation (or aspect) combinable with any other example implementation (or aspect), each voltage signal transmitted by each computer chip is transmitted to a controller that is communicatively coupled to each computer chip by a common wire.

In an example implementation (or aspect), a method comprises: placing an electrochemical cell assembly within a housing, wherein the electrochemical cell assembly comprises a plurality of electrochemical cells, a flow manifold, and a coupler comprising a fluid conduit, a first electrical conduit, and a second electrical conduit, wherein the housing defines a fluid port, a first electrical port, and a second electrical port, wherein the fluid conduit of the coupler is configured to be fluidically coupled to the fluid port of the housing, wherein the first electrical conduit of the coupler is configured to be electrically coupled to the first electrical port of the housing, wherein the second electrical conduit of the coupler is configured to be electrically coupled to the second electrical port of the housing; placing an incompressible adhesive within the housing, such that an annular space defined between the plurality of electrochemical cells and the housing is at least partially filled with the incompressible adhesive, and the plurality of electrochemical cells are surrounded by the incompressible adhesive; and hermetically sealing, by the incompressible adhesive, the plurality of electrochemical cells to prevent the plurality of electrochemical cells from being exposed to pressure that is external to the incompressible adhesive.

In an example implementation (or aspect) combinable with any other example implementation (or aspect), the incompressible adhesive is placed within the housing while the electrochemical cell assembly is placed within the housing.

In an example implementation (or aspect) combinable with any other example implementation (or aspect), the method comprises, prior to placing the electrochemical cell assembly within the housing, wrapping at least a portion of the electrochemical cell assembly with a polymer sleeve, and the electrochemical cell assembly wrapped with the polymer sleeve is placed within the housing.

In an example implementation (or aspect) combinable with any other example implementation (or aspect), the method comprises applying the incompressible adhesive to the electrochemical cell assembly to surround the plurality of electrochemical cells, and the electrochemical cell assembly and the incompressible adhesive are simultaneously placed within the housing, due to the incompressible adhesive being applied to the electrochemical cell assembly.

What is claimed is:

1. An electrochemical cell assembly comprising:
a first separator;
a second separator, wherein the first separator and the second separator define a fluid compartment of an electrochemical cell between the first separator and the second separator, wherein the fluid compartment has a positive compartment and a negative compartment;
a positive electrode within the positive compartment;
a negative electrode within the negative compartment;
a housing defining a fluid port, a first electrical port, and a second electrical port;
a flow manifold in fluid communication with the fluid compartment;
a coupler comprising:
a fluid conduit for fluid communication between the fluid port and the flow manifold;
a first electrical conduit electrically connecting the first electrical port to the positive electrode; and
a second electrical conduit electrically connecting the second electrical port to the negative electrode; and
an incompressible adhesive disposed between the electrochemical cell and the housing.

2. The electrochemical cell assembly of claim 1, comprising a plurality of electrochemical cells, wherein the flow manifold comprises a plurality of designated flow lines, wherein each designated flow line is connected to each electrochemical cell, wherein each designated flow line is designated for a distinct feed.

3. The electrochemical cell assembly of claim 2, wherein each electrochemical cell comprises a frame within which the respective electrolyte is disposed and a computer chip embedded in the frame.

4. The electrochemical cell assembly of claim 3, comprising a controller communicatively coupled to each computer chip, wherein each computer chip is configured to transmit a voltage signal to the controller representing a voltage of the respective electrochemical cell.

5. The electrochemical cell assembly of claim 4, wherein the controller is communicatively connected to each computer chip by a common wire.

6. The electrochemical cell assembly of claim 2, wherein the electrodes of the plurality of electrochemical cells are electrically connected in a series configuration.

7. The electrochemical cell assembly of claim 2, comprising an electrical manifold electrically connected to the first electrical conduit, the second electrical conduit, and each of the plurality of electrochemical cells, wherein the electrodes of the plurality of electrochemical cells are electrically connected in a parallel configuration by the electrical manifold.

8. The electrochemical cell assembly of claim 2, wherein an annular space defined between the plurality of electrochemical cells and the housing is at least partially filled with the incompressible adhesive, wherein the plurality of electrochemical cells are surrounded by the incompressible adhesive, and the incompressible adhesive is configured to hermetically seal the plurality of electrochemical cells within the housing, such that the plurality of electrochemical cells are prevented from exposure to pressure that is external to the incompressible adhesive.

9. A method comprising:
flowing an inlet stream to an electrochemical cell assembly comprising a plurality of electrochemical cells disposed within a housing defining a fluid port, a first electrical port, and a second electrical port, wherein the inlet stream is flowed into the fluid port of the housing;
hermetically sealing, by an incompressible adhesive, the plurality of electrochemical cells within the housing to prevent the plurality of electrochemical cells from being exposed to pressure that is external to the incompressible adhesive;
flowing the inlet stream from the fluid port through a fluid conduit disposed within a coupler disposed within the housing;
distributing, by a flow manifold in fluid communication with the fluid conduit, the inlet stream to at least one of the plurality of electrochemical cells, wherein the inlet stream interacts with an electrolyte of the at least one of the plurality of electrochemical cells in a reduction-oxidation reaction to produce an outlet stream; and
discharging the outlet stream from the housing.

10. The method of claim 9, comprising transmitting, by the first electrical port, electrical power through a first electrical conduit disposed within the coupler to the at least one of the plurality of electrochemical cells, thereby causing the reduction-oxidation reaction involving the inlet stream and the electrolyte of the at least one of the plurality of electrochemical cells to occur.

11. The method of claim 9, comprising:
generating, by each electrochemical cell, electrical power in response to the reduction-oxidation reaction involving the inlet stream and the electrolyte of the respective electrochemical cell; and
transmitting, by the second electrical conduit, the generated electrical power from each electrochemical cell.

12. The method of claim 9, wherein each electrochemical cell comprises a frame within which the respective electrolyte is disposed and a computer chip embedded in the frame, and the method comprises transmitting, by each computer chip, a voltage signal representing a voltage of the respective electrochemical cell.

13. The method of claim 12, wherein each voltage signal transmitted by each computer chip is transmitted to a controller that is communicatively coupled to each computer chip by a common wire.

14. A method comprising:
placing an electrochemical cell assembly within a housing, wherein the electrochemical cell assembly comprises a plurality of electrochemical cells, a flow manifold, and a coupler comprising a fluid conduit, a first electrical conduit, and a second electrical conduit, wherein the housing defines a fluid port, a first electrical port, and a second electrical port, wherein the fluid conduit of the coupler is configured to be fluidically coupled to the fluid port of the housing, wherein the first electrical conduit of the coupler is configured to be electrically coupled to the first electrical port of the housing, wherein the second electrical conduit of the coupler is configured to be electrically coupled to the second electrical port of the housing;
placing an incompressible adhesive within the housing, such that an annular space defined between the plurality of electrochemical cells and the housing is at least partially filled with the incompressible adhesive, and the plurality of electrochemical cells are surrounded by the incompressible adhesive; and
hermetically sealing, by the incompressible adhesive, the plurality of electrochemical cells to prevent the plurality of electrochemical cells from being exposed to pressure that is external to the incompressible adhesive.

15. The method of claim 14, wherein the incompressible adhesive is placed within the housing while the electrochemical cell assembly is placed within the housing.

16. The method of claim 14, comprising, prior to placing the electrochemical cell assembly within the housing, wrapping at least a portion of the electrochemical cell assembly with a polymer sleeve, and the electrochemical cell assembly wrapped with the polymer sleeve is placed within the housing.

17. The method of claim 14, comprising applying the incompressible adhesive to the electrochemical cell assembly to surround the plurality of electrochemical cells, and the electrochemical cell assembly and the incompressible adhesive are simultaneously placed within the housing, due to the incompressible adhesive being applied to the electrochemical cell assembly.
